(19) United States
(12) Patent Application Publication
(10) Pub. No.: US 2019/0114369 A1
(43) Pub. Date: Apr. 18, 2019

(54) MULTIDIMENSIONAL GRAPH STRUCTURED DATABASE WITH PROPERTY AND RELATIONSHIP SUBCLASSES

(71) Applicant: Bank of America Corporation, Charlotte, NC (US)

(72) Inventors: Brandon Sloane, Santa Barbara, CA (US); John Howard Kling, Cincinnati, OH (US); Ronald James Kuhlmeier, Simi Valley, CA (US)

(21) Appl. No.: 15/786,153

(22) Filed: Oct. 17, 2017

(51) Int. Cl. G06F 17/30; G06F 21/62; G06F 21/31

(52) U.S. Cl. CPC G06F 17/30958; G06F 17/30427; G06F 21/31; G06F 21/6218; G06F 17/30991

(57) ABSTRACT

The invention provides a multidimensional graph database with property and relationship subclasses. In comparison to current graph database technology, which only allows for the creation of nodes, relationships, and properties for the nodes and relationships, the new multidimensional graph database treats properties as a separate object class. In this way, each property may in turn have one or more of its own properties and/or relationships to other nodes, relationships, or properties. The system is able to add as many layers of properties and relationships as needed to precisely represent the data as well as the relationships between and/or amongst the data. By extending the graph database schema beyond the conventional bounds, the multidimensional graph database increases the efficiency of database queries while simultaneously increasing the depth and quality of the data produced by the search queries.

### FIELD OF THE INVENTION

The present invention embraces a system, computer program product, and method for storing and retrieving data in a multidimensional graph database with property and relationship subclasses.

### BACKGROUND

Traditional relational (e.g. SQL) databases typically arrange data within tables and employ join algorithms to establish relationships between sets of data. As the data and relationships amongst the data become increasingly complex, the computational cost of querying relationships becomes highly burdensome for the computing systems which host the database. Furthermore, traditional graph databases only allow relationships or nodes to be defined to a single dimension, which limits the level of detail and granularity to which data can be precisely defined. Accordingly, there is a need to arrange a database that may efficiently express relationships between complicated sets of data and provide for multiple dimensions of detail to allow the system to accurately capture the complexity of the data therein.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides a multidimensional graph database with property and relationship subclasses. In comparison to current graph database technology, which only allows for the creation of nodes, relationships, and properties for the nodes and relationships, the new multidimensional graph database treats properties as a separate object class. In this way, each property may in turn have one or more of its own properties and/or relationships to other nodes, relationships, or properties. The system is able to add as many layers of properties and relationships as needed to precisely represent the data as well as the relationships between and/or amongst the data. By extending the graph database schema beyond the conventional bounds, the multidimensional graph database increases the efficiency of database queries while simultaneously increasing the depth and quality of the data produced by the search queries.

Embodiments of the present invention provide a system, computer program product, and a computer-implemented method for storing and retrieving data in a multidimensional graph database. The invention comprises generating, within the graph database, a first node; generating, within the graph database, a second node; establishing a relationship between the first node and the second node, wherein the first node is designated as a first source and the second node is designated as a first target; associating a first base-level property with the first node; and associating a first second-level property with the first base-level property.

In some embodiments, the invention further comprises associating a second base-level property with the second node; and associating a second second-level property with the second base-level property.

In some embodiments, the invention further comprises receiving, over a network, a search query from a user, wherein the search query comprises a starting node and a search parameter; translating, via a query processor, the search query into a set of low level instructions; executing, via the database control system, the low level instructions to begin the search at the starting node; retrieving data from the graph database according to the starting node and the search parameter; and presenting the data to the user via a user interface.

In some embodiments, the invention further comprises receiving authentication credentials from the user; determining that the user requires administrative access; and granting, to the user, permission to add, modify, and remove data within the graph database.

In some embodiments, the invention further comprises receiving authentication credentials from the user; determining that the user does not require administrative access; and granting, to the user, permission to query and retrieve data from the graph database.

In some embodiments, the invention further comprises establishing a relationship between the first second-level property and the second second-level property, wherein the first second-level property is designated as a second source and the second second-level property is designated as a second target.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a line and symbol diagram illustrating some of the data structures that may exist within the multidimensional graph database, in accordance with one embodiment of the present invention;

FIG. 2 is a block diagram illustrating an operating environment for the graph database, in accordance with one embodiment of the present invention;

FIG. 3 is a block diagram illustrating the graph database computing system and the user computing system in more detail, in accordance with one embodiment of the present invention; and

FIG. 4 illustrates a process flow for storing and retrieving data in a multidimensional graph database, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates a system of networked computing devices and/or systems on which the graph database is implemented. The entity may be a business organization, a non-profit organization, a government organization, and the like. In other embodiments, the entity may be a single individual who wishes to log data and complex interactions amongst the data sets.

“User” as used herein may refer to an individual who may utilize the graph database. The user may be an agent, administrator, or employee of the entity who has authorization to add, modify, or delete data, or query existing data. In other embodiments, the user may be a client or customer of the entity. In yet other embodiments, the user may be unaffiliated with the entity who has some type of interaction with the entity's system.

“Computing system” as used herein may refer to a networked computing device within the entity system. The computing system may include a processor, a non-transitory storage medium, a communications device, and a display. The computing system may support user logins and inputs from any combination of similar or disparate devices. Accordingly, the computing system may be a portable electronic device such as a smartphone, tablet, or laptop, or the computing system may be a stationary unit such as a personal desktop computer, networked terminal, or server. In some embodiments, the computing system may be a local or remote server which is configured to send and/or receive inputs from other computing systems on the network.

“Node” as used herein may refer to a data structure which represents an entity or an individual. Accordingly, a node may represent an organization, a person, an object such as a computing system, or intangibles such as events.

“Relationship” as used herein may refer to a data structure that links one node to another. Typically, the relationship has a source node and a target node, and explains how the nodes subject to the relationship are related. In some embodiments, a node may also have a relationship with itself.

“Property” as used herein may refer to a label which may be applied to nodes, relationships, and other properties. Properties may create groups of sets organized by common properties, in which nodes, relationships, and properties that have the same property belong to the same set. Each node, relationship, and property may have more than one property associated with it.

Embodiments of the present invention provide a system, computer program product, and method for arranging a multidimensional graph database. In particular, the new graph database modifies the data structures and the associated query language to allow each node, relationship, and property to be further defined by one or more properties and/or relationships. For example, a node may have a property that is defined by another property, which may in turn have relationships to nodes, relationships, and other properties. In this way, the database schema may be extended in multiple dimensions to the extent necessary to accurately capture the data to be tracked. In other words, additional layers of properties and relationships can be defined in relationship to existing nodes, properties and relationships to increase the fidelity of the information stored in the database. The query language may also be expanded to account for the added potential complexity of the database.

The multidimensional graph database provides a number of significant enhancements to computing technology in comparison to traditional databases. Allowing the system to define multiple dimensions of properties and relationships allows the database to store data and define properties and relationships to a level of detail and granularity that is not technologically possible with currently existing databases. Furthermore, arranging nodes, relationships, and properties in this manner allows the system to reduce the time that it takes to retrieve complex data and relationships in response to a search query. In other words, the database is both highly scalable and efficient, which improves the functioning of the computing systems on which the databases are deployed by reducing the computing resources required to run the database and execute search queries. Said computing resources may include processing power, memory space, storage space, cache space, electric power, and networking bandwidth.

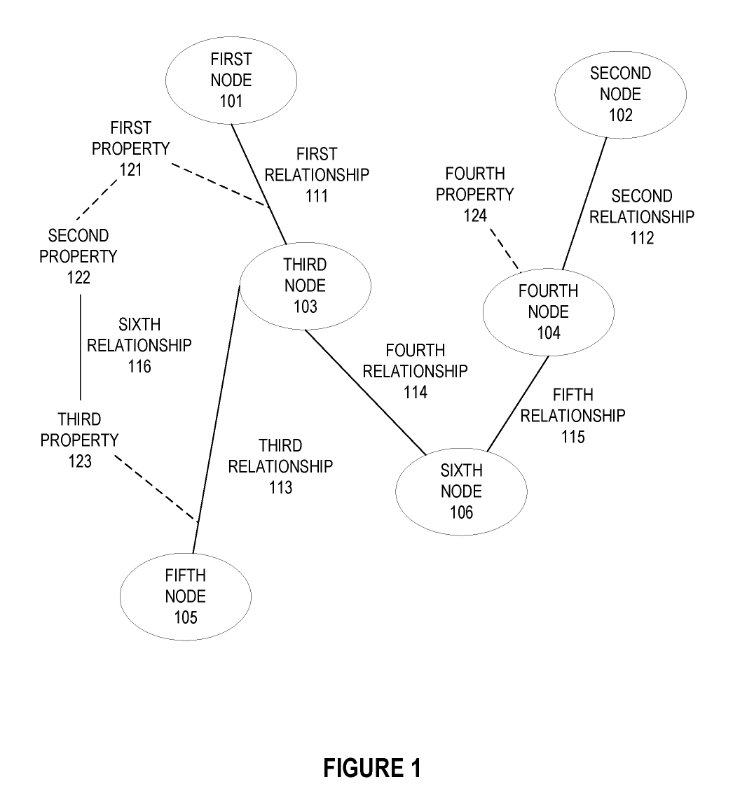

FIG. 1 is a line and symbol diagram illustrating some of the data structures that may exist within the multidimensional graph database, in accordance with one embodiment of the present invention. The graph database may comprise a plurality of nodes which represent the items to be tracked by the database. Relationships are represented using solid lines while properties are represented using dashed lines. In an exemplary embodiment, the graph database may comprise a first node 101, a second node 102, a third node 103, a fourth node 104, a fifth node 105, and a sixth node 106. One or more properties may be associated with each node within the graph database. For example, the fourth node 104 may be associated with a fourth property 124.

The plurality of nodes may be connected to one another via one or more relationships. The relationships serve to explain the manner in which the nodes are connected. Continuing the example as detailed above, the first node 101 may be connected to the third node 103 by a first relationship 111, the second node 102 may connected to the fourth node 104 by a second relationship 112, the third node 103 may be connected to the fifth node 105 by a third relationship 113 and to the sixth node 106 by a fourth relationship 114, and the fourth node 104 may be connected to the sixth node 106 by a fifth relationship 115. In some embodiments, the relationships themselves may be associated with one or more properties. For example, the first relationship 111 may be associated with a first property 121, and the third relationship 113 may be associated with a third property 123.

In some embodiments, the properties within the graph database may in turn be associated with one or more other properties. For example, the first property 121 may be associated with a second property 122. In some embodiments, the properties may be connected with other properties via relationships. For instance, the second property 122 may be connected to the third property 123 by a sixth relationship 116. In this way, the database is more capable of expressing complex interactions between the nodes, relationships, and properties in multiple dimensions.

To further illustrate an exemplary embodiment of the present invention, an entity may wish to track data on users and computers which are connected to cybersecurity attack events on the entity's systems. In such an embodiment, the first node 101 and the second node 102 may each represent computing systems which were used to carry out a cyber-attack. For instance, the first node 101 may represent a first computing system and the second node 102 may represent a second computing system. The first node 101 and the second node 102 may each be associated with a number of properties which describe the computing systems, such as IP address, operating system, geographic area, the networks on which the system operates, and the like.

The third node 103 and the fourth node 104 may each represent attackers who are implicated in a cyber-attack carried out on the entity's systems. For instance, the third node 103 may represent a first attacker and the fourth node 104 may represent a second attacker. In some embodiments, the attacker may be an individual. In other embodiments, the attacker may be an entity, such as a company or a government organization. The third node 103 and the fourth node 104 may each be associated with a number of properties that describe the identity of the attacker, which may include a name, biographical information, aliases, geographic origin, and the like. The third node 103 may serve as the source node for the first relationship 111 to the first node 101, where the first relationship 111 denotes ownership. In this way, the database is able to express that the first attacker owns the first computing system. Likewise, the fourth node 104 may serve as the source node for the second relationship 112 to the second node 102, where the second relationship 112 also denotes ownership. Through this relationship, it is evident that the second attacker owns the second computing system.

The fifth node 105 and the sixth node 106 may represent specific cyber-attack incidents carried out on the entity's systems. For instance, the fifth node 105 may represent a first attack while the sixth node 106 may represent a second attack. The fifth node 105 and the sixth node 106 may be associated with a number of properties which describe the nature of the attack, which may include the date and time, whether the attack was successful, the specific exploit used, the resolution of the attack, and the like. The third node 103 may be connected to the fifth node 105 by the third relationship 113 and to the sixth node 106 by the fourth relationship 114, where the third relationship 113 establishes that the first attacker was involved in the first attack, and the fourth relationship 114 establishes that the first attacker was involved in the second attack. Likewise, the fourth node 104 may be connected to the sixth node 106 by the fifth relationship 115, where the fifth relationship 115 establishes that the second attacker was involved in the second attack.

The various relationships within the graph database may themselves be associated with properties. For instance, the first relationship 111, which establishes that the first attacker owns the first computing system, may be associated with the first property 121, where the first property 121 indicates that the relationship (i.e. ownership of the computing system) existed for a particular date range. Similarly, the third relationship 113, which establishes that the first attacker was involved in the first attack, may be associated with the third property 123 indicates that the attacker's involvement fits into a particular category of attack. The various properties within the graph database may in turn be associated with other properties. For example, the first property 121, which establishes ownership of the first computing system within a certain date range, may be associated with a second property 122, which establishes that said date range is associated with a major company filing. Properties may also themselves be linked to other properties via relationships. For instance, the second property 122 may be linked to the third property 123 by the sixth relationship 116, where the sixth relationship 116 establishes that the particular category of attack into which the first attack falls was the most common attack for the date range of the major company filing.

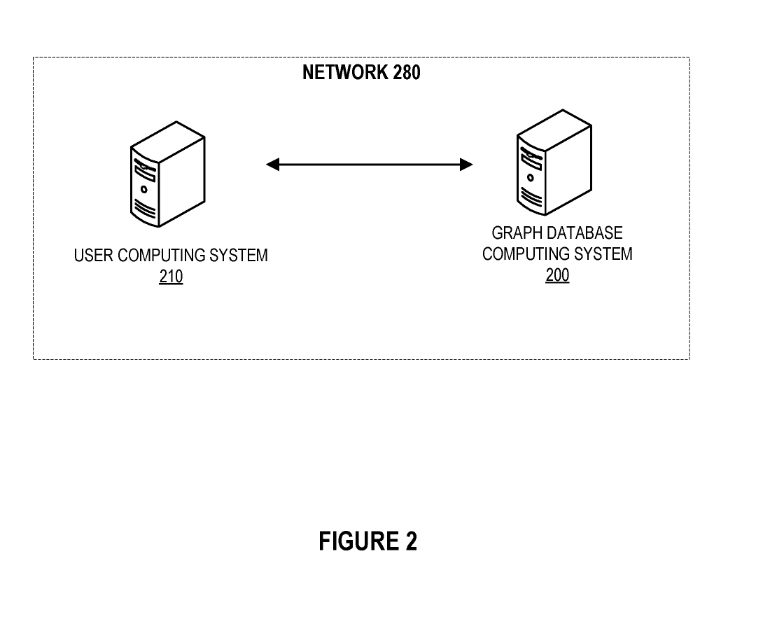

FIG. 2 is a block diagram illustrating an operating environment for the graph database, in accordance with one embodiment of the present invention. The operating environment may include a graph database computing system 200 in operative communication with a user computing system 210 over a network 280. The network 280 may, for example, be a global area network (GAN), such as the Internet, a wide area network (WAN), a local area network (LAN), or any other type of network or combination of networks. The network 280 may provide for wireline, wireless, or a combination wireline and wireless communication between the various devices and computing systems on the network 280.

The graph database computing system 200 comprises the hardware and software necessary to run the multidimensional graph database, and may store the data within the graph database, maintain the data, accept search queries, and deliver search results and authorize access to the queried data. It should be understood by those of ordinary skill in the art that the various devices and computing systems as depicted herein may be embodied in a single device or computing system or multiple devices and/or computing systems, which may be either separate from one another or operatively connected to one another in a distributed fashion. For instance, the graph database computing system 200 as depicted herein may be owned and operated by an entity and comprise a series of computing systems acting in parallel to execute the functions of the graph database computing system 200. Similarly, it should be understand that the user computing system 210 as depicted herein may represent multiple computing systems owned and operated by different users to access the graph database computing system 200.

The user computing system 210 may be owned and operated by user and be used to access the multidimensional graph database on the graph database computing system 200. In some embodiments, the user may be an individual, such as a customer of the entity, an administrator or employee of the entity, or a member of the public. In other embodiments, the user may be an entity. Generally, the user is authorized by the graph database computing system 200 to access the graph database therein. For instance, if the user is an administrator or employee of the entity, the user may be authorized to add data structures to the graph database, such as new nodes, relationships, or properties. The system may also allow the user to add additional layers of properties and/or relationships to existing data, or to modify, update, or delete existing data within the graph database as necessary. The system may further authorize the user to construct and execute search queries on the graph database according to a query language that supports the retrieval of the multidimensional properties and relationships of the multidimensional graph database.

The graph database computing system 200 may allow for a variety of different methods through which data may be entered into the graph database. In some embodiments, the user may directly input the data into the graph database and is given the authorization to create nodes, relationships, and properties within the graph database. In other embodiments, data may be acquired via a data feed from third party servers. Typically, the data feed takes unstructured data, interprets it, and translates it into a structured data set to fit into the structure of the graph database. In other embodiments, the data within the graph database may be generated via machine learning. In such embodiments, data may be generated using an external data source or system, such as by crawling the web to identify connections to be made between the various nodes and properties. The data may alternatively be generated using internal sources. For instance, the system may identify existing mappings created using nodes, relationships, and properties within the graph database and suggest additional mappings to the user.

The graph database may further be configured to be ACID compliant in order to ensure that database transactions are completed in a timely and stable manner. An ACID compliant database comprises atomicity (i.e. each database transaction is verified for integrity), consistency (i.e. each data entry is verified for consistency with database rules), isolation (i.e. each database transaction is able to be processed independently), and durability (i.e. data is resistant to failures).

In some embodiments, the graph database computing system 200 may comprise a database control system, which is configured to receive user-submitted queries and manage run time access to the database. The conversion of user-submitted queries may be achieved through a query processor, which may translate the queries and/or commands inputted by the user into low level instructions which may then be executed by the runtime database manager. In this way, the system is able to provide a layer of abstraction through which the user may use identifiable commands to execute the addition, deletion, modification, querying, and retrieval functions of the graph database. The database control system may further serve the function of maintaining the structure and fidelity of the data by the use of error checking and/or correction.

In some embodiments, the graph database computing system 200 may further comprise a database engine which controls that secures and provides access to the data. The database engine may be responsible for authorizing and/or authenticating users and restricting some functions of the graph database depending on the user class. For instance, an administrator of the entity's systems may be provided with the least restrictive rule set, which may allow the administrator to freely add, remove, edit, and query the data within the database. On the other hand, a client of the entity may be provided only with access to the query functions of the database, while a member of the public may be precluded from utilizing any of the functions of the graph database.

The graph database computing system 200 may further comprise a report generation utility which extracts information from the database and presents it to the user in a number of different formats. The user may be able to select specific records for viewing in a desired format, such as graphs, charts, tables, formatted text, and the like. For illustrate, the user may be an administrator of the entity may wish to gather data on cyber-attacks carried out on the entity's systems for the purposes of strengthening its security countermeasures and/or prevention methods. If the user wishes to retrieve data on the most frequently encountered exploit or type of attack, the user may wish to sort the queried data through a table to allow for ease of calculations. On the other hand, if the user wishes to retrieve data on the geographic locations of the attacks, the user may wish to display the retrieved data on a chart such as a map. Alternatively, if the user wishes to retrieve data on the frequency of a particular type of attack over a certain period of time, the user may wish to display the retrieved data on a labeled graph. As the system allows for increasingly complex data and relationships, the report generation utility is also able to display the complex data in a way that is most relevant and comprehensible to the user.

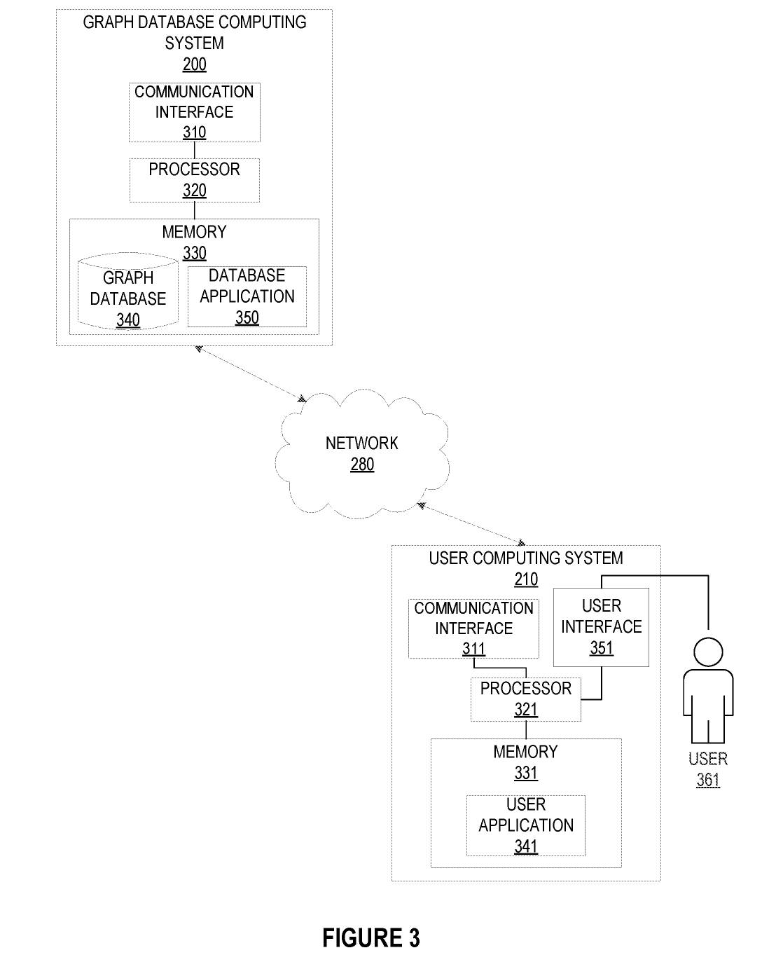

FIG. 3 is a block diagram illustrating the graph database computing system 200 and the user computing system 210 in more detail, in accordance with one embodiment of the present invention. The graph database computing system 200 typically contains a processor 320 communicably coupled to such devices as a communication interface 310 and a memory 330. The processor 320, and other processors described herein, typically includes circuitry for implementing communication and/or logic functions of the various computing systems as depicted herein. For example, the processor 320 may include a digital signal processor device, a microprocessor device, and various analog to digital converters, digital to analog converters, and/or other support circuits.

The graph database computing system 200 may use the communication interface 310 to communicate with other computing systems and devices over the network 380. The communication interface 310 as used herein may include an Ethernet interface, an antenna coupled to a transceiver configured to operate on a cellular data or WiFi signal, and/or a near field communication (“NFC”) interface.

The graph database computing system 200 may include a memory 330 operatively coupled to the processor 320. As used herein, memory includes any computer readable medium (as defined herein below) configured to store data, code, or other information. The memory 330 may include volatile memory, such as volatile Random Access Memory (RAM) including a cache area for the temporary storage of data. The memory 330 may also include non-volatile memory, which can be embedded and/or may be removable. The non-volatile memory can additionally or alternatively include an electrically erasable programmable read-only memory (EEPROM), flash memory or the like. A database application 350 may be stored within the memory 330 of the graph database computing system 200. When executed, database application 350 may be responsible for providing access to the database, maintaining the data within the database, executing add, edit, delete, or other modifying functions in relation to the database, and/or receiving and processing search queries. Accordingly, the database application 350 may comprise the query processor, database control system, database engine, and the report generation utility which provide the functions as described above.

The graph database 340 may be stored within the memory 330, where the graph database 340 may contain the data that the entity wishes to track. Typically, the graph database 340 is accessible and modifiable by the employees or administrators of the entity. On the other hand, the graph database 340 may provide only query and retrieval access to other authorized users, such as clients of the entity. It should be understand that while the graph database 340 is depicted as a singular item, the graph database 340 may in fact be stored within the memories of a plurality of servers as needed to distribute workload and optimize computing efficiency.

The user computing system 210 may comprise a communication interface 311, a processor 321, and a memory 331 having a user application 341 stored thereon. The user application 341 may comprise the logic code that, when executed, allows the user 361 to access the graph database 340 within the graph database computing system 200. In some embodiments, the user application 341 may be an application provided by the entity to allow access to the entity's systems. In other embodiments, the user application 341 may be a third party application such as a web browser. In some embodiments, depending on the status of the user 361, the user application 341 may allow or restrict certain functions with respect to the database. For instance, the user application 341 may restrict the editing or modification functions of the user application 341 if the user 361 is a client of the entity, thereby allowing the user 361 only to view and/or retrieve data records within the graph database 340. In other embodiments, the user application 341 may allow the user 361 to add records if the user 361 is, for example, an employee of the entity. In yet other embodiments, the user application 341 may allow the user 361 to freely add, modify, delete, retrieve, and query data records in the event that the user 361 is, for example, a database administrator who requires access to these functions. In some embodiments, the processor 321 may interact with the user 361 via a user interface 351. The user interface 351 typically comprises the software and hardware needed to receive input from the user and provide output to the user 361. Accordingly, the user interface 351 may receive input from the user 361 through, for example, keyboards, keypads, touch interfaces, cameras, motion sensors, microphones, mice, and the like. The user interface 351 may also provide output to the user 361 through such devices as a monitor, screen, projection, speakers, headphones, haptic devices, and the like. Typically, the user 361 utilizes the user interface 351 to access the user application 341 stored in the memory 331, which in turn allows the user computing system 210 to communicate, over the network 280, with the database application 350. The database application 350 may then accept inputs such as queries, edit requests, and the like, and pull the data from the graph database 340 for presentation to the user in the format in which the user 361 desires to view the data.

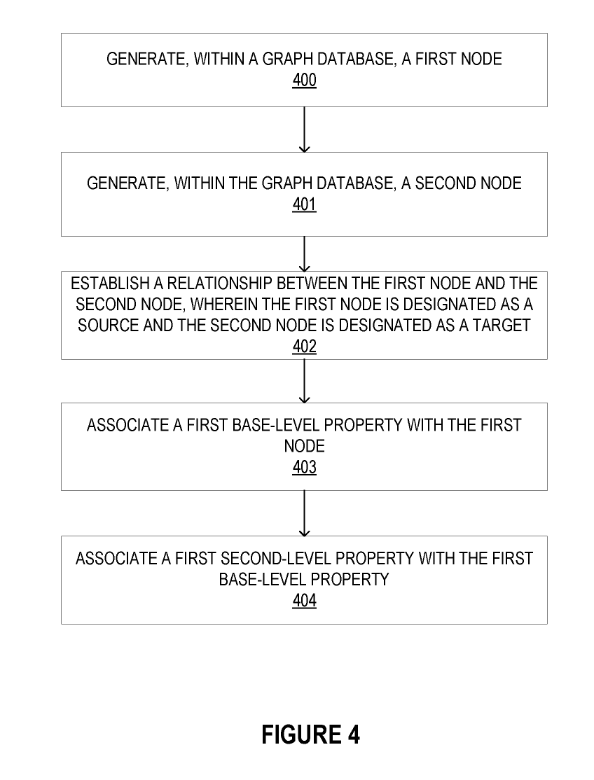

FIG. 4 illustrates a process flow for storing and retrieving data in a multidimensional graph database, in accordance with one embodiment of the present invention. The process begins at block 400, where the system generates, within a graph database, a first node. Typically, the first node is a data entry that represents an item that the entity wishes to track. The first node is capable of being associated with one or more properties to further define the first node. The properties serve as labels which serve to categorize the nodes with which the label is associated; that is, all nodes, relationships, and properties associated with a particular property belong to the same group.

At this point, if the system receives a search query containing the properties from the user, the system may retrieve and display the nodes, relationships, and properties associated with the property. Generally, the system requires the user to specify a starting node for a query, then add flags as necessary to complete the query. For instance, if the user wishes to retrieve data on all cyber-attacks in which a particular attacker is implicated, the user must specify the node corresponding to the attacker. The system then begins the search at the attacker's node. The system then branches out to identify and retrieve the other nodes, relationships, and properties relevant to the user's query.

Furthermore, the properties associated with the node are in turn capable of being associated with other properties. In this way, a significantly greater amount of detailed data may be stored with respect to each node. As a corollary, the types of queries that may be executed may be significantly more precise compared to traditional queries of graph databases. The first node is further configured to be linked to other nodes via relations. The first node may, in some embodiments, serve as the source node of the relationship, which is typically directional. For instance, if the relationship may be expressed as “parent of,” the first node as the source node will be the “parent of” the target node. In other embodiments, the first node may serve as the target node to another source node in a different relationship. The first node may also be connected to node via multiple relationships, which may in some embodiments be bi-directional. For instance, the relationship expressed as “siblings” may apply in both directions to the target node and the source node.

The process continues to block 401, where the system generates, within the graph database, a second node. The second node typically represents a second item that the entity wishes to track. As was the case with the first node, the second node is able to be associated with one or more properties, where said properties may in turn be associated with one or more properties. The second node, like other nodes in the system, be able to be connected by relationships to other nodes in the database, either as the source node or the target node.

The process continues to block 402, where the system establishes a relationship between the first node and the second node, wherein the first node is designated as a source and the second node is designated as a target. In this example, the first node is the source node and has an “outgoing” relationship, while the second node is the target node and has an “incoming” relationship. In some embodiments, the relationship may be directional in a singular manner. For instance, if the first node represents an attacker and the second node represents a computer, and the relationship is defined as “owner of,” the relationship must flow from the first node to the second node (i.e. the first node is the owner of the second node, or the attacker is the owner of the computer). In other embodiments, the relationship may be bidirectional. For instance, if the first node represents a first attacker and the second node represents a second attacker, and the relationship is defined as “knows,” the relationship implicitly goes both ways (i.e. the first attacker knows the second attacker AND the second attacker knows the first attacker). That said, it should be noted that while relationships are generally directional, the relationships may be traversed from either direction; it is not necessary to build a duplicate and/or opposite relationship for the system to understand the relationship between two nodes. In some embodiments, the relationship itself may be associated with a property. In the example in which the first attacker knows the second attacker, the “knows” relationship may be modified with a second-level property which may explain the length of time the attackers have known each other, the degree of closeness of their relationships, their past interactions, and the like. These second-level properties may in turn have third level properties. For instance, if the second-level property is the time the attackers have known each other, the third-level property may be a date range, an elapsed time, and the like.

The process continues to block 403, where the system associates a first base-level property with the first node. The first base-level property exists in the first dimension of the node; that is, the first base-level property directly labels the first node to further define the nature of the first node. For instance, if the first node represents a cyber attacker, the first base-level property may be a name, place of origin, age, etc. It is typically useful for the user to utilize these base-level properties to define broad or high-level labels which is relevant to the entity's purposes for keeping the database.

The process concludes at block 404, where the system associates a first second-level property with the first base-level property. The second-level properties exist in the second dimension with respect to the node; that is, the second-level property in this case modifies the base-level property. For example, if the base-level property is a name, then the second level property may be a legal name, an alias, a screen name, nickname, and the like. Alternatively, if the base-level property is a place of origin, the second-level property may be geographic location, organizational membership, and the like. It should be node here that the second-level property may in turn be associated with a third-level property, and the third-level property may be associated with a fourth-level property, and so on. Each property may also be linked by relationships to other nodes, relationships, and properties. For instance, the second-level property of one node may be linked via a relationship to the third-level property of another node. In this way, not only is the system able to store highly detailed data and information on the interconnectedness of the data, but is also able to avoid the need to traverse a large number of nodes to retrieve the complex data in response to a search query, which in turn greatly increases the computing efficiency and scalability of the multidimensional graph database.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A multidimensional graph database system, comprising:
a processor;
a communication interface; and
a memory having a database application and a graph database stored therein, wherein the database application, when executed by the processor, causes the processor to:
generate, within the graph database, a first node;
generate, within the graph database, a second node;
establish a relationship between the first node and the second node, wherein the first node is designated as a first source and the second node is designated as a first target;
associate a first base-level property with the first node; and
associate a first second-level property with the first base-level property.

2. The system according to claim 1, wherein the database application further causes the processor to:
associate a second base-level property with the second node; and
associate a second second-level property with the second base-level property.

3. The system according to claim 1, wherein the database application further causes the processor to:
receive, over a network, a search query from a user, wherein the search query comprises a starting node and a search parameter;
translate, via a query processor, the search query into a set of low level instructions;
execute, via a database control system, the low level instructions to begin a search at the starting node;
retrieve data from the graph database according to the starting node and the search parameter; and
present the data to the user via a user interface.

4. The system according to claim 3, wherein the database application further causes the processor to:
receive authentication credentials from the user;
determine that the user requires administrative access; and
grant, to the user, permission to add, modify, and remove data within the graph database.

5. The system according to claim 3, wherein the database application further causes the processor to:
receive authentication credentials from the user;
determine that the user does not require administrative access; and
grant, to the user, permission to query and retrieve data from the graph database.

6. The system according to claim 2, wherein the database application further causes the processor to establish a relationship between the first second-level property and the second second-level property, wherein the first second-level property is designated as a second source and the second second-level property is designated as a second target.

7. A computer program product for storing and retrieving data in a multidimensional graph database, the computer program product comprising at least one non-transitory computer readable medium having computer-readable program code portions embodied therein, the computer-readable program code portions comprising:
an executable portion for generating, within the graph database, a first node;
an executable portion for generating, within the graph database, a second node;
an executable portion for establishing a relationship between the first node and the second node, wherein the first node is designated as a first source and the second node is designated as a first target;
an executable portion for associating a first base-level property with the first node; and
an executable portion for associating a first second-level property with the first base-level property.

8. The computer program product according to claim 7, the computer-readable program code portions further comprising:
an executable portion for associating a second base-level property with the second node; and
an executable portion for associating a second second-level property with the second base-level property.

9. The computer program product according to claim 7, the computer-readable program code portions further comprising:
an executable portion for receiving, over a network, a search query from a user, wherein the search query comprises a starting node and a search parameter;
an executable portion for translating, via a query processor, the search query into a set of low level instructions;
an executable portion for executing, via a database control system, the low level instructions to begin a search at the starting node;
an executable portion for retrieving data from the graph database according to the starting node and the search parameter; and
an executable portion for presenting the data to the user via a user interface.

10. The computer program product according to claim 9, the computer-readable program code portions further comprising:
an executable portion for receiving authentication credentials from the user;
an executable portion for determining that the user requires administrative access; and
an executable portion for granting, to the user, permission to add, modify, and remove data within the graph database.

11. The computer program product according to claim 9, the computer-readable program code portions further comprising:
an executable portion for receiving authentication credentials from the user;
an executable portion for determining that the user does not require administrative access; and
an executable portion for granting, to the user, permission to query and retrieve data from the graph database.

12. The computer program product according to claim 8, the computer-readable program code portions further comprising an executable portion for establishing a relationship between the first second-level property and the second second-level property, wherein the first second-level property is designated as a second source and the second second-level property is designated as a second target.

13. A computer-implemented method for storing and retrieving data in a multidimensional graph database, said method comprising:
generating, within the graph database, a first node;
generating, within the graph database, a second node;
establishing a relationship between the first node and the second node, wherein the first node is designated as a first source and the second node is designated as a first target;
associating a first base-level property with the first node; and
associating a first second-level property with the first base-level property.

14. The computer-implemented method according to claim 13, the method further comprising:
associating a second base-level property with the second node; and
associating a second second-level property with the second base-level property.

15. The computer-implemented method according to claim 13, the method further comprising:
receiving, over a network, a search query from a user, wherein the search query comprises a starting node and a search parameter;
translating, via a query processor, the search query into a set of low level instructions;
executing, via a database control system, the low level instructions to begin a search at the starting node;
retrieving data from the graph database according to the starting node and the search parameter; and
presenting the data to the user via a user interface.

16. The computer-implemented method according to claim 15, the method further comprising:
receiving authentication credentials from the user;
determining that the user requires administrative access; and
granting, to the user, permission to add, modify, and remove data within the graph database.

17. The computer-implemented method according to claim 15, the method further comprising:
receiving authentication credentials from the user;
determining that the user does not require administrative access; and
granting, to the user, permission to query and retrieve data from the graph database.

18. The computer-implemented method according to claim 14, the method further comprising establishing a relationship between the first second-level property and the second second-level property, wherein the first second-level property is designated as a second source and the second second-level property is designated as a second target.
